(19) United States
(12) Patent Application Publication
(10) Pub. No.: US 2025/0128255 A1
(43) Pub. Date: Apr. 24, 2025

(54) MICROFLUIDIC SUBSTRATE AND MICROFLUIDIC CHIP

(71) Applicant: Tianjin MNCHIP Technologies Co.,Ltd, Tianjin (CN)

(72) Inventors: Zhanhui WANG, Tianjin (CN); Tianle ZHANG, Tianjin (CN); Shuxiang WANG, Tianjin (CN)

(73) Assignee: Tianjin MNCHIP Technologies Co.,Ltd, Tianjin (CN)

(21) Appl. No.: 18/907,438

(22) Filed: Oct. 4, 2024

(30) Foreign Application Priority Data
Oct. 20, 2023 (CN) 202311361354.4

(51) Int. Cl. B01L 3/00

(52) U.S. Cl. CPC B01L 3/50273; B01L 2200/025; B01L 2200/16; B01L 2300/041; B01L 2300/0803; B01L 2400/0409

(57) ABSTRACT

Provided are a microfluidic substrate, and a microfluidic chip. The microfluidic substrate includes a flow channel structure, the flow channel structure includes a conveying flow channel including an input end and an output end; a recovery assembly including a waste liquid tank, and a second micro flow channel in communication with the waste liquid tank at one end and in communication with the output end of the conveying flow channel at another end; and multiple detection assemblies arranged between the input end and the output end. Each detection assembly includes a first fluid tank, a first micro flow channel and a second fluid tank, which are in communication in turn. The first fluid tank communicates with the conveying flow channel, and a reagent is provided in at least one second fluid tank. A critical rotational speed of the first micro flow channel for blocking a fluid is set as a first rotational speed, and the second micro flow channel is configured to block the fluid at the first rotational speed. The design can prevent the fluid in the conveying flow channel from preferentially entering the waste liquid tank, thus ensuring the amount of fluid introduced into the second fluid tank.

### TECHNICAL FIELD

The present disclosure relates to the field of analysis detection, and in particular to a microfluidic substrate, and a microfluidic chip.

### BACKGROUND

Microfluidics chip technology has great potential in biology, chemistry, medicine and other fields, and has developed into a brand-new interdisciplinary research field of biology, chemistry, medicine, fluid, electronics, materials, machinery and the like. Centrifugal microfluidic which drives fluids and controls the amount of fluids through centrifugal force in micro flow channels has the advantages of high degree of integration, automation, miniaturization and parallel detection of multiple samples or indicators, and has become an important branch in the field of microfluidic chip technology.

However, the current microfluidic chip is limited to its own structural design, and is easy to have inaccurate detection results due to factors such as the difficulty in controlling the fluid injection amount in the reaction chamber, which cannot meet the demand for high detection accuracy of the user.

### SUMMARY

A first aspect of the present disclosure provides a microfluidic substrate, including a flow channel structure. The flow channel structure includes a conveying flow channel, a recovery assembly, and multiple detection assemblies. The conveying flow channel includes an input end and an output end. The multiple detection assemblies are arranged between the input end and the output end, and each detection assembly includes a first fluid tank, a first micro flow channel and a second fluid tank, which are in communication with one another in turn. The first fluid tank communicates with the conveying flow channel, and a reagent is provided in at least one second fluid tank. The recovery assembly includes a waste liquid tank, and a second micro flow channel. One end of the second micro flow channel communicates with the waste liquid tank, and the other end of the second micro flow channel communicates with the output end of the conveying flow channel. A critical rotational speed of the first micro flow channel for blocking a fluid is set as a first rotational speed, and the second micro flow channel is configured to block the fluid at the first rotational speed.

In above scheme, the fluid in the conveying flow channel can be prevented from preferentially entering the waste liquid tank, thus ensuring that the fluid stored in the first fluid tank may be completely introduced into the second fluid tank, and ensuring the amount of fluid introduced into the second fluid tank.

In a specific embodiment of the first aspect of the present disclosure, the first micro flow channel is configured to have a first length and first cross-sectional area, such that a fluid from the first fluid tank and a gas in the second fluid tank form a gas-liquid interface in the first micro flow channel at the first rotational speed. In addition, the second micro flow channel is configured to have a second length and second cross-sectional area, such that a fluid from the conveying flow channel and a gas in the waste liquid tank form a gas-liquid interface in the second micro flow channel at the first rotational speed.

In a specific embodiment of the first aspect of the present disclosure, a critical rotational speed of the second micro flow channel for blocking the fluid is set as a second rotational speed. The microfluidic substrate has a rotation axial center, the detection assembly and the recovery assembly are located at one side, away from the rotation axial center, of the conveying flow channel, and the first fluid tank is configured to make the fluid in the conveying flow channel enter the first fluid tank at a third rotational speed.

For example, the first rotational speed is greater than the third rotational speed, and the second rotational speed is not equal to the third rotational speed. In this way, after the fluid enters the conveying flow channel (e.g., from a mixing tank below), the rotational speed needs to be increased to make the fluid pass through the first micro flow channel. Before that, it can be ensured that the fluid entering the conveying flow channel completely fills the first fluid tank.

For example, the first rotational speed is equal to the third rotational speed, and the second rotational speed is greater than or equal to the third rotational speed. In this way, the fluid will enter the first fluid tank automatically while entering the conveying flow channel (e.g., the mixing tank below), and passes through the first micro flow channel under the action of a centrifugal force. In such a case, the second micro flow channel can still block the fluid, thus ensuring that the fluid entering the conveying flow channel preferably enters the second fluid tank.

In a specific embodiment of the first aspect of the present disclosure, the recovery assembly further includes a third fluid tank, the second micro flow channel communicates with the conveying flow channel through the third fluid tank, and the third fluid tank is configured to enable the fluid in the conveying flow channel to enter the third fluid tank at the third rotational speed.

In a specific embodiment of the first aspect of the present disclosure, each of the first micro fluid channel and the second micro flow channel is a non-siphon flow channel. The first rotational speed is equal to the second rotational speed, where the first length is equal to the second length, and/or the first cross-sectional area is equal to the second cross-sectional area.

In above scheme, the fluid in the conveying flow channel can enter both the waste liquid tank and the recovery assembly (e.g., the second fluid tank and the buffer tank below), thus preventing the fluid that has been stored in the first fluid tank from entering the waste liquid tank.

In another specific embodiment of the first aspect of the present disclosure, each of the first micro fluid channel and the second micro flow channel is a non-siphon flow channel. The first rotational speed is less than the second rotational speed, where the first length is less than the second length, and/or the first cross-sectional area is greater than the second cross-sectional area.

In the above scheme, compared with the first micro flow channel, the blocking effect of the second micro flow channel on the fluid is stronger. When a centrifugal force provided by the rotational speed (greater than the first rotational speed and less than the second rotational speed) makes the gas-liquid interface of the first micro flow channel damaged, while the gas-liquid interface may still be maintained in the second micro flow channel.

In another specific embodiment of the first aspect of the present disclosure, the first micro fluid channel is a non-siphon flow channel, the second micro flow channel is a siphon flow channel, and the second rotational speed is less than the third rotational speed. A distance from a part of the second micro flow channel to the rotation axial center is less than a distance from the output end to the rotation axial center. Thus, the fluid in the conveying flow channel can be introduced into the waste liquid tank under the action of siphon.

In a specific embodiment of the first aspect of the present disclosure, each detection assembly further includes a buffer tank and a third micro flow channel. The first fluid tank, the first micro flow channel, the buffer tank, the third micro flow channel and the second fluid tank are in communication in turn. For example, further, the third micro flow channel is configured to block the fluid at a fourth rotational speed, and the fourth rotational speed is greater than the first rotational speed.

In above scheme, the buffer tank is configured to prevent the liquid in the first fluid tank from making contact with a preloaded reagent in the second fluid tank in advance, which accurately controls the reaction time of the reagent in the second fluid tank, and further reduces the risk of cross-contamination of reagents in various detection assemblies.

In a specific embodiment of the first aspect of the present disclosure, the sum of volumes of the second fluid tank and the buffer tank is not less than a volume of the first fluid tank. Therefore, the fluid stored in the first fluid tank can be stored in the buffer tank after fully filling the second fluid tank, thus preventing the fluid from flowing back to the conveying flow channel to cause the cross-contamination between different detection assemblies.

In a specific embodiment of the first aspect of the present disclosure, a shape of the conveying flow channel is a non-closed ring, the ring is a part of a circle, and the center of the circle where the ring is located is the rotation axial center. Otherwise, the shape of the conveying flow channel is a non-closed ring, the ring is a part of the non-circle, the shape of the conveying flow channel is a non-closed ring, the distance from the input end to the rotation axial center is less than that from the output end to the rotation axial center, and the distance from the conveying flow channel to the rotation axial center increases gradually in a direction from the input end to the output end. The ring is a part of the non-circle, the distance from the input end of the rotation axial center is greater than that from the output end to the rotation axial center, and the distance from the conveying flow channel to the rotation axial center decreases gradually in a direction from the input end to the output end.

In above scheme, the rotation of the microfluidic substrate rotates is beneficial to uniform distribution of the fluid in the conveying flow channel, such that the fluid can flow into the first fluid tank in each detection assembly evenly. In addition, in a case that the distance from the conveying flow channel to the rotation axial center increases gradually in a direction from the input end to the output end, the residual fluid in the conveying flow channel can be gathered to the output end to ensure that the residual fluid can completely enter the waste liquid tank. In addition, the overall design size of the microfluidic substrate can be reduced in the case that the distance from the conveying flow channel to the rotation axial center decreases gradually in a direction from the input end to the output end, which is beneficial to the miniaturization design of the microfluidic substrate.

In a specific embodiment of the first aspect of the present disclosure, the microfluidic substrate may also include a mixing tank and a fourth micro flow channel. The mixing tank communicates with the input end of the conveying flow channel through the fourth micro flow channel, and the volume of the mixing tank is greater than the sum of the volumes of the conveying flow channel and the first fluid tank. Thus, when the fluid enters the conveying flow channel from the mixing tank, it can be ensured that there is a height difference between the fluid in the mixing tank and the fluid in the conveying flow channel, making the fluid completely fill the conveying flow channel and all the first fluid tanks.

In a specific embodiment of the first aspect of the present disclosure, the microfluidic substrate may include a flow channel layer and a base. The flow channel structure is formed in the flow channel layer. The base is located at the other side, away from one side provided with the first fluid tank, the first micro flow channel, the second micro flow channel, the second fluid tank and the waste liquid tank, of the flow channel layer. The base is attached to the flow channel layer, or the base and the flow channel layer are integrally formed.

In a second aspect of the present disclosure, a microfluidic chip is provided, and includes a cover plate and the microfluidic substrate in the first aspect. The cover plate is aligned with and closed to the microfluidic chip, and is located at one side provided with a first fluid tank, a first micro flow channel, a second micro flow channel, a second fluid tank and a waste liquid tank, of the microfluidic substrate.

### BRIEF DESCRIPTION OF THE DRAWINGS

FIG. 1 is a structural schematic diagram of a microfluidic substrate according to an embodiment of the present disclosure;

FIG. 2 is a structural schematic diagram of a partial region of a microfluidic substrate shown in FIG. 1;

FIG. 3 is a sectional view of a microfluidic substrate taken along M1-N1 shown in FIG. 2;

FIG. 4 is a sectional view of a microfluidic substrate taken along M2-N2 shown in FIG. 2;

FIG. 5 is a structural schematic diagram of a partial region of another microfluidic substrate according to an embodiment of the present disclosure;

FIG. 6 is a structural schematic diagram of a partial region of another microfluidic substrate according to an embodiment of the present disclosure;

FIG. 7 is a structural schematic diagram of a partial region of another microfluidic substrate according to an embodiment of the present disclosure;

FIG. 8 is a structural schematic diagram of a partial region of another microfluidic substrate according to an embodiment of the present disclosure;

FIG. 9 is a structural schematic diagram of a partial region of another microfluidic substrate according to an embodiment of the present disclosure;

FIG. 10 is a structural schematic diagram of a partial region of another microfluidic substrate according to an embodiment of the present disclosure;

FIG. 11 is a sectional view of a partial region of a microfluidic chip according to an embodiment of the present disclosure;

FIG. 12 is a sectional view of another partial region of a microfluidic chip according to an embodiment of the present disclosure.

### DETAILED DESCRIPTION OF THE EMBODIMENTS

The following clearly and completely describes the technical solutions in the embodiments in this specification with reference to the accompanying drawings in the embodiments of this specification. Apparently, the described embodiments are merely a part rather than all of the embodiments of this specification. All other embodiments obtained by those of ordinary skill in the art based on the embodiments of this specification without creative efforts shall fall within the scope of protection of this specification.

Microfluidics refers to the science and technology involved in the system that uses micro flow channels (tens to hundreds of microns in size) to handle or manipulate micro-fluids (nano-liter to micro-liter in volume), and is a new interdisciplinary subject involving chemistry, fluid physics, microelectronics, new materials, biology and biomedical engineering. Because of its miniaturization and integration, microfluidic devices are usually called microfluidic chips, which may also be called Lab on a Chip, or micro-Total Analytical System.

In the microfluidic chip, a conveying flow channel and multiple detection tanks (e.g., the second fluid tank in the following embodiment) are provided, and reagents are pre-loaded in the detection tanks, for example, different reagents are pre-loaded in different detection tanks, such that multiple detections of the sample can be achieved in one detection process. Each detection tank is provided with a holding tank (e.g., a first fluid tank in the following embodiment) to pre-store the fluid injected into each detection tank. In the actual detection process, before a fluid containing the sample is injected into the detection tank, the fluid needs to be injected into the holding tank to pre-store the fluid injected into each detection tank. After each holding tank is injected with the fluid, the fluid in the holding tank can be injected into the detection tank by means such as increasing the rotational speed, while the excess fluid will enter the waste liquid tank. However, in the actual process, when the fluid in the conveying flow channel enters the waste liquid tank, a part of the fluid which has been already stored in the holding tank can be taken away (e.g., due to factors such as fluid viscosity and surface tension), which makes the fluid finally entering the detection tank too little, leading to the reduction of detection accuracy or even the failure to complete the detection.

In view of this, at least one embodiment of the present disclosure provides a microfluidic substrate to at least solve the technical problem above. A microfluidic substrate includes a flow channel structure. The flow channel structure includes a conveying flow channel, a recovery assembly, and multiple detection assemblies. The conveying flow channel includes an input end and an output end. The multiple detection assemblies are arranged between the input end and the output end, and each detection assembly includes a first fluid tank, a first micro flow channel, and a second fluid tank, which are in communication with one another in turn. The first fluid tank communicates with the conveying flow channel, and a reagent is provided in at least one second fluid tank. The recovery assembly includes a waste liquid tank and a second micro flow channel. One end of the second micro flow channel communicates with the waste liquid tank, and the other end of the second micro flow channel communicates with the output end of the conveying flow channel. A critical rotational speed of the first micro flow channel for blocking a fluid is set as a first rotational speed, and the second micro flow channel is configured to block the fluid at the first rotational speed. Thus, the fluid in the conveying flow channel will not preferentially enter the waste liquid tank, a situation that the fluid entering the second fluid tank is less due to the fact that excessive fluid in the conveying flow channel enters the waste liquid tank can be avoided, thus ensuring that the fluid stored in the first fluid tank can be completely introduced into the second fluid tank, ensuring the amount of the fluid introduced into the second fluid tank, and ensuring the detection quality of the microfluidic substrate.

In the following, the specific structures of the microfluidic substrate and the microfluidic chip in at least one embodiment according to the present disclosure are described in detail with reference to the drawings.

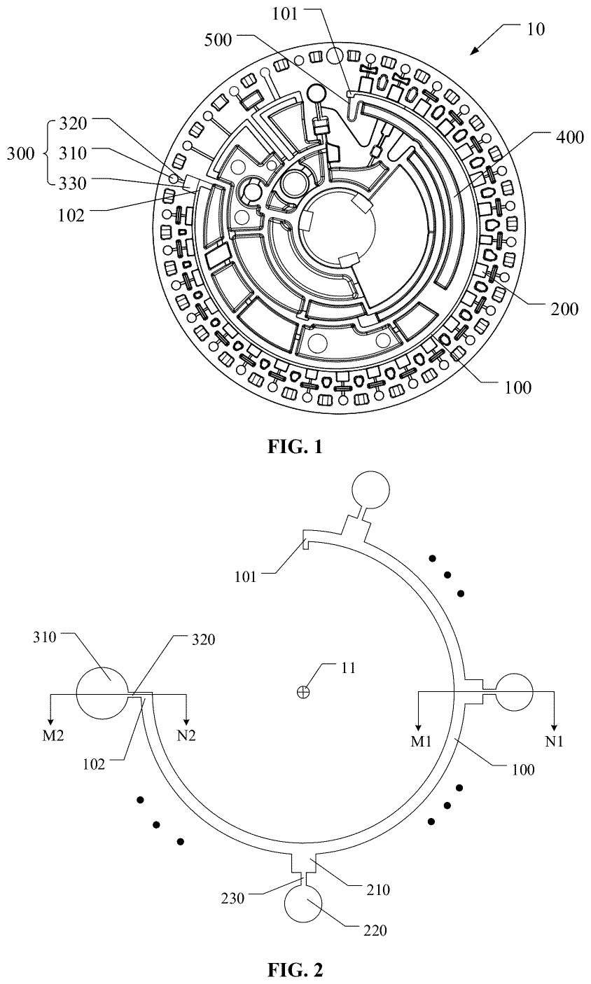

As shown in FIG. 1 to FIG. 4, a microfluidic substrate 10 includes a flow channel structure. The flow channel structure includes a conveying flow channel 100, multiple detection assemblies 200, and a recovery assembly 300. The conveying flow channel 100 includes an input end 101 and an output end 102. The multiple detection assemblies 200 are arranged between the input end 101 and the output end 102, and each detection assembly 200 includes a first fluid tank 210, a first micro flow channel 230, and a second fluid tank 220, which are in communication with one another in turn. The first fluid tank 210 communicates with the conveying flow channel 100, and a reagent for detection is provided in at least one second fluid tank 220. The recovery assembly 300 includes a waste liquid tank 310, and a second micro flow channel 320. One end of the second micro flow channel 320 communicates with the waste liquid tank 310, and the other end of the second micro flow channel 320 communicates with the output end 102 of the conveying flow channel 100.

A critical rotational speed of the first micro flow channel 230 to block the fluid is set as a first rotational speed, that is, when the rotational speed is greater than or less than the first rotational speed, the fluid in the first fluid tank 210 breaks through the blocking of the first micro flow channel 230 to enter the second fluid tank 220. The second micro flow channel 320 is provided to block the fluid at the first rotational speed, that is, at the first rotational speed, the fluid in the conveying flow channel 100 cannot break through the blocking of the second micro flow channel 320, and thus cannot enter the waste liquid tank 310. Thus, at a certain rotational speed (e.g., a third rotational speed below), the fluid enters the conveying flow channel 100 from the input end 101 and flows towards the output end 102 along the conveying flow channel 200. In this process, the fluid fills the first fluid tanks 210 in turn, and after the fluid fills all the first fluid tanks 210, in a case that the rotational speed is increased to close to or equal to the first rotational speed, the first micro flow channel 230 and the second micro flow channel 320 can still block the fluid. After the rotational speed is increased to be greater than the first rotational speed, the fluid in the first micro flow channel 230 break through the blocking of the first micro flow channel 230, that is, the fluid in the first micro flow channel 230 does not break through the blocking after the fluid in the second micro flow channel 320, thus ensuring that the fluid pre-stored in the first fluid tank 210 can completely enter the second fluid tank 220.

It should be noted that in actual operation, the rotational speed can be directly increased to be greater than the first rotational speed from the above “certain rotational speed (e.g., the third rotational speed below)”, which is not limited to first increasing the rotational speed to the first rotational speed and then further increasing the rotational speed to be greater than the first rotational speed.

In an embodiment of the present disclosure, the first micro flow channel is configured to have a first length and first cross-sectional area, such that a fluid from the first fluid tank and a gas in the second fluid tank form a gas-liquid interface in the first micro flow channel at the first rotational speed. In addition, the gas-liquid interface may be located at one end (which may also be called the output end), away from the first fluid tank, of the first micro flow channel. Correspondingly, the second micro flow channel is configured to have a second length and second cross-sectional area, such that a fluid from the conveying flow channel and a gas in the waste liquid tank form a gas-liquid interface in the second micro flow channel at the first rotational speed. Taking the first micro flow channel as an example, in the actual process, the fluid entering the second fluid tank through the conveying flow channel can include two stages: in a first stage, the fluid flows to the bottom (a portion, away from the rotation axial center, of the first fluid tank) of the first fluid tank along a side wall of the first fluid tank through the conveying flow channel at a low rotational speed, and due to the existence of interfacial tension, an inlet of the first micro flow channel at the bottom of the first fluid groove be closed, the fluid continuously entering the first fluid tank further enters the first micro flow channel under the driving of the centrifugal force, and the air closed in the second fluid tank is compressed to generate a reverse pressure. When the reverse pressure and the surface tension of the fluid reach a balance with the centrifugal force, the fluid in the first micro flow channel stops flowing, thus forming a stable gas-liquid interface in the first micro flow channel. At this time, the first fluid tank has been filled with the fluid. In a second stage, the rotational speed is increased to increase the centrifugal force, thus breaking the balance at the gas-liquid interface. The fluid passes through the first micro flow channel and continues to flow into the second fluid tank, making the fluid pre-stored in each first fluid tank flow into the corresponding second fluid tank. In this case, the closed air can be discharged through the first micro flow channel.

It needs to be noted that the rotational speed required when the gas-liquid interface is broken can be controlled by controlling the length and cross-sectional area of the micro flow channel (e.g., the product of the width and the depth). For example, the longer the length and/or the smaller the cross-sectional area of the micro flow channel, the stronger the retention effect of the micro flow channel itself on the fluid, and the greater the rotational speed required to break the gas-liquid interface formed in the micro flow channel.

In at least one embodiment of the present disclosure, as shown in FIG. 1 to FIG. 5, the microfluidic substrate 10 has a rotation axial center 11, the detection assembly 200 and the recovery assembly 300 are located at one side, away from the rotation axial center 11, of the conveying flow channel 100. A critical rotational speed of the second micro flow channel for blocking the fluid is set as a second rotational speed, the first fluid tank 210 is configured such that the fluid in the conveying flow channel 100 can enter the first fluid tank 210 at the third rotational speed.

For example, in some embodiments, the first rotational speed is greater than the third rotational speed, and the second rotational speed is not equal to the third rotational speed. Thus, at the third rotational speed, it can be ensured that the fluid fills the first fluid tank 210 in the process of entering the conveying flow channel 100, without entering the waste liquid tank 310. That is, after the fluid enters the conveying flow channel 100 (e.g., from the mixing tank below), the rotational speed needs to be increased to make the fluid pass through the first micro flow channel 230, and before that, it can be ensured that the fluid entering the conveying flow channel 100 completely fills the first fluid tank 210.

For example, in some other embodiments, the first rotational speed is equal to the third rotational speed, and the second rotational speed is greater than or equal to the third rotational speed. Thus, the fluid enters the first fluid tank 210 while entering the conveying flow channel 100 (e.g., the mixing groove below), and can pass through the first micro flow channel 230 at the same time under the action of the centrifugal force. In this case, the second micro flow channel 320 can still block the fluid, thus ensuring that the fluid entering the conveying flow channel 100 enters the second fluid tank 220 preferentially (directly or indirectly, e.g., through the buffer tank below).

In some embodiments of the present disclosure, referring to FIG. 2 again, the second micro flow channel 320 may directly communicate with the output end 102 of the conveying flow channel 100.

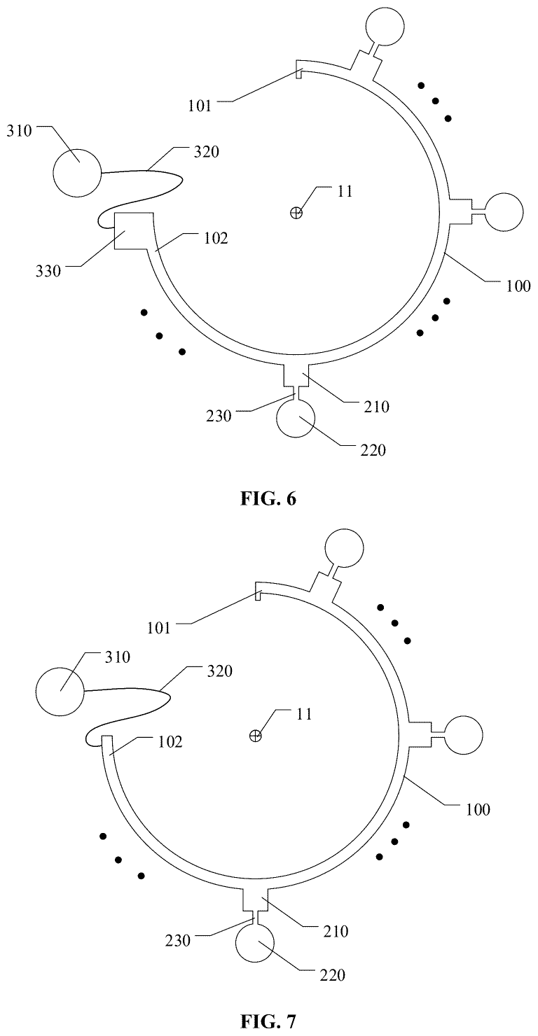

In some other embodiments of the present disclosure, as shown in FIG. 5, the recovery assembly may also include a third fluid tank 300. In this case, the second micro flow channel 320 communicates with the conveying flow channel 100 through the third fluid tank 330, that is, the third fluid tank 330 is located between the second micro flow channel 320 and the conveying flow channel 100. The third fluid tank 303 is configured to make the fluid in the conveying flow channel 100 enter the third fluid tank 330 at the third rotational speed. For example, the design size of the conveying flow channel 100 may be set to be the same as that of the first fluid tank 210.

In an embodiment of the present disclosure, it is only necessary to ensure that the second micro flow channel does not allow the fluid to pass before the first micro flow channel. In this case, it is optional to make the fluids in the first micro flow channel and the second micro flow channel break through the blocking at the same time (at the same rotational speed), or the first micro flow channel and the second micro flow channel can be configured to make the fluids break through the blocking at different rotational speeds. In the latter case, the centrifugal force provided by the rotational speed can be simply used to make the fluid pass through the second micro flow channel, or other means such as siphon force can be used to make the fluid pass through the second micro flow channel. In the following, the implementation principles of these modes are explained through different embodiments.

In some embodiments of the present disclosure, each of the first micro flow channel and the second micro flow channel is a non-siphon flow channel, and the first rotational speed is equal to the second rotational speed. As shown in FIG. 5, when the rotational speed is the first rotational speed (equivalent to the second rotational speed), the gas-liquid interface in the first micro flow channel 230 is located at an end, away from the conveying flow channel 100, of the first micro flow channel 230, and the gas-liquid interface in the second micro flow channel 320 is also located at an end, away from the conveying flow channel 100, of the second micro flow channel 320. When the rotational speed is further increased to be greater than the first rotational speed, the gas-liquid interfaces in the first micro flow channel 230 and the second micro flow channel 320 are simultaneously broken, that is, the fluid in the conveying flow channel 100 simultaneously enters the waste liquid tank 310 and the second fluid tank 220. In this design, the lengths and/or cross-sectional areas of the first micro flow channel 230 and the second flow channel 320 may be configured to be identical, that is, the first length is equal to the second length, and/or the first cross-sectional area is equal to the second cross-sectional area.

In some other embodiments of the present disclosure, each of the first micro flow channel and the second micro flow channel is a non-siphon flow channel, and the first rotational speed is less than the second rotational speed. As shown in FIG. 5, when the rotational speed is the first rotational speed, the gas-liquid interface in the first micro flow channel 230 is located at an end, away from the conveying flow channel 100, of the first micro flow channel 230, and the gas-liquid interface in the second micro flow channel 320 has not yet reached an end, away from the conveying flow channel 100, of the second micro flow channel 320. Compared with first micro flow channel 230, the blocking effect of the second micro flow channel 320 on the fluid is stronger. When the centrifugal force provided by the rotational speed (greater than the first rotational speed and less than the second rotational speed) makes the gas-liquid interface of the first micro flow channel 230 broken, the gas-liquid interface can still be maintained in the second micro flow channel 320. Thus, the fluid in the conveying flow channel 100 can be guaranteed to enter the second fluid tank 220 preferentially, and the amount of fluid entering the second fluid tank 220 is guaranteed. In this design, the first micro flow channel 230 is weaker than the second micro flow channel 320 in blocking fluid. For example, the relationship between the lengths and/or cross-sectional areas of the first micro flow channel 230 and the second micro flow channel 320 can be designed as follows: the first length is less than the second length, and/or the first cross-sectional area is greater than the second cross-sectional area.

In some other embodiments of the present disclosure, as shown in FIG. 6 or FIG. 7, the first micro flow channel 230 is a non-siphon channel, the second micro flow channel 320 is a siphon channel, the second rotational speed is less than the third rotational speed, and the distance from the part of the second micro flow channel 320 (referred to as the middle part here) to the rotation axial center is less than the distance from the output end 102 to the rotation axial center 11. Thus, at the third rotational speed, the fluid in the conveying flow channel 100 fills the first fluid tank 210, and in the second micro flow channel 320, as the middle part of the second micro flow channel 320 is closer to the rotation axial center 11 than the output end of the conveying flow channel 100, the siphon force cannot overcome the centrifugal force, such that the gas-liquid interface cannot pass through the middle part of the second micro flow channel 320. Then, the rotational speed is increased to exceed the first rotational speed to make the fluid in the first fluid tank 210 enter the second fluid tank 220. In this case, the centrifugal force on the fluid in the second micro flow channel 320 is further increased, which makes it more difficult for the gas-liquid interface to pass through the middle part of the second micro flow channel 320. Thereafter, after the fluid in the first fluid tank 210 completely enters the second fluid tank 220, the rotational speed is reduced to be less than the second rotational speed (and less than the third rotational speed at the same time). At this time, due to the reduction of the centrifugal force, the siphon force has overcome the centrifugal force, and the gas-liquid interface can pass through the middle part of the second micro flow channel 320, such that the remaining fluid in the conveying flow channel 100 can be finally introduced into the waste liquid tank 310.

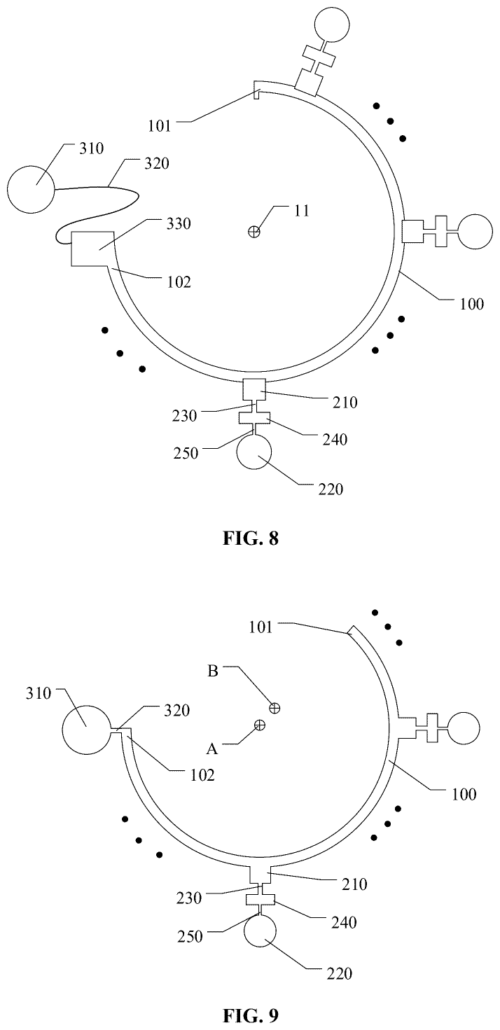

In the actual process, at the stage of injecting the fluid into the first fluid tank to pre-store the fluid, the fluid in the first fluid tank may flow into the second fluid tank to mix with the reagent to start the reaction in advance, which may cause errors in the detection results. Therefore, in some embodiments of the present disclosure, a buffer tank may be arranged between the first fluid tank and the second fluid tank to solve this problem. For example, as shown in FIG. 8 or FIG. 9, each detection assembly may also include a buffer tank 240 and a third micro flow channel 250. The first fluid tank 210, the first micro flow channel 230, the buffer tank 240, the third micro flow channel 250 and the second fluid tank 220 are in communication in turn. For example, the third micro flow channel 250 may be configured to have enough cross-sectional area so as not to block the fluid, or the third micro flow channel 250 may be configured to block the fluid at the fourth rotational speed, and the fourth rotational speed is greater than the first rotational speed. In the case that the third micro flow channel 250 is configured to block the fluid, in the actual process, after the remaining fluid in the conveying flow channel 100 enters the waste liquid tank 310 (at this time, the fluid pre-stored in the first fluid tank 210 has entered the buffer tank 240), the rotational speed can be increased to be greater than the fourth rotational speed, such that the fluid stored in the buffer tank 240 can enter the second fluid tank 220. By providing the buffer tank 240, the liquid in the first fluid tank 210 can be prevented from making contact with the pre-loaded reagent in the second fluid tank 220 in advance, thus accurately controlling the reaction time of the reagent in the second fluid tank 220, and reducing the risk of cross contamination of reagents in various detection assemblies.

For example, the sum of the volumes of the second fluid tank 220 and the buffer tank 240 is not less than the volume of the first fluid tank 210. Thus, the fluid stored in the first fluid tank 210 can be stored in the buffer tank 240 after fully filling the second fluid tank 220, thus preventing the fluid from flowing back to the conveying flow channel 100 to cause the cross-contamination between different detection assemblies.

In at least one embodiment of the present disclosure, the shape of the conveying flow channel is a non-closed ring, the ring is a part of a circle, and the center of the circle where the ring is located is the rotation axial center. Otherwise, the shape of the conveying flow channel is a non-closed ring, the ring is a part of the non-circle, the shape of the conveying flow channel is a non-closed ring, the distance from the input end to the rotation axial center is less than that from the output end to the rotation axial center, and the distance from the conveying flow channel to the rotation axial center increases gradually in a direction from the input end to the output end. Otherwise, the ring is a part of the non-circle, the distance from the input end of the rotation axial center is greater than that from the output end to the rotation axial center, and the distance from the conveying flow channel to the rotation axial center decreases gradually in a direction from the input end to the output end.

For example, as shown in FIG. 8, the conveying flow channel 100 of the microfluidic substrate 100 is a circular arc (is a non-closed ring), and the rotation axial center 11 is the center of a circle where the circular arc is located.

For example, as shown in FIG. 9, the shape of the microfluidic substrate 10 shown in FIG. 8 can be modified to shift a position of the rotation axial center from A to B, then the distance from the input end 101 of the conveying flow channel 100 to the rotation axial center is less than that from the output end 102 of the conveying flow channel to the rotation axial center, and the distance from the conveying flow channel 100 to the rotation axial center increases gradually in a direction from the input end 101 to the output end 102. In a case that the distance from the conveying flow channel to the rotation axial center increases gradually in a direction from the input end 101 to the output end 102, the remaining fluid in the conveying flow channel 100 can be gathered to the output end 102 to ensure that the remaining fluid can enter the waste liquid tank 310.

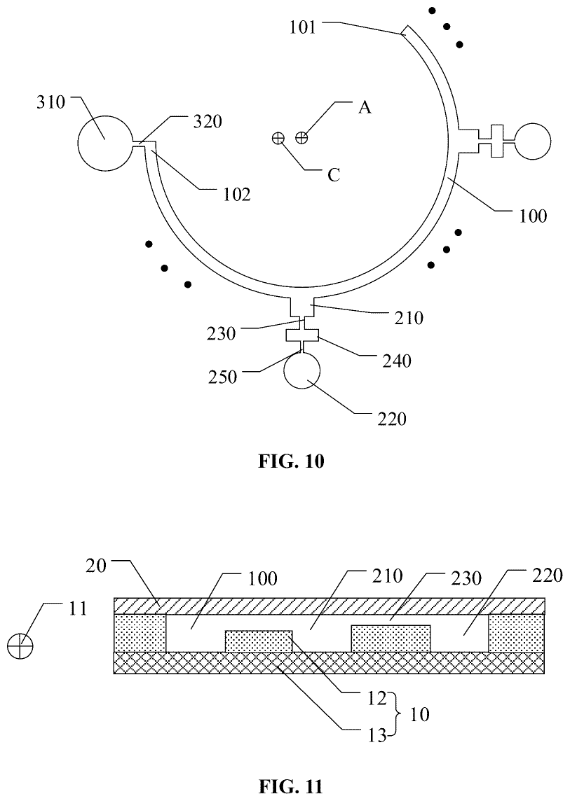

For example, as shown in FIG. 10, the shape of the microfluidic substrate 10 shown in FIG. 8 can be modified to shift the position of the rotation axial center from A to C, then the distance from the input end 101 of the conveying flow channel 100 to the rotation axial center is less than that from the output end 102 of the conveying flow channel to the rotation axial center, and the distance from the conveying flow channel 100 to the rotation axial center increases gradually in a direction from the input end 101 to the output end 102.

It needs to be noted that the shape of the conveying flow channel is also not limited to the circular arc, as long as the shape is designed to follow the above law. Thus, the rotation of the microfluidic substrate is beneficial for the fluid to be evenly distributed in the conveying flow channel 100, and the fluid can evenly flow into the first fluid tank 210 in each detection assembly.

In at least one embodiment of the present disclosure, referring to FIG. 1 and FIG. 2 again, the microfluidic substrate 10 may also include a mixing tank 400 and a fourth micro flow channel 500. The mixing tank 400 communicates with the input end 101 of the conveying flow channel 100 through the fourth micro flow channel 500. The mixing tank includes at least two inlets and one outlet. One end of the fourth micro flow channel 500 communicates with the outlet of the mixing tank 400, and the other end of the fourth micro flow channel 500 is connected to the conveying flow channel 100. A distance from a part of the fourth micro flow channel 500 to the rotation axial center 11 is less than that from the mixing tank 400 to the rotation axial center 11. The mixing tank 400 communicates with the conveying flow channel 100 through the fourth micro flow channel 500. The at least two inlets of the mixing tank 400 can be used for introducing at least two types of fluids (e.g., samples and diluents), respectively, and the two types of fluids can be evenly mixed in the mixing tank 400. The mixed fluid enters the conveying flow channel 100 through the fourth micro flow channel 500. For example, after the sample and the diluent enter the mixing tank 400 through the two inlets of the mixing tank 400, respectively, the microfluidic substrate 10 keeps rotating. Due to the fact that the distance from the part of the fourth micro flow channel 500 to the rotation axial center 11 is less than that from the mixing tank 400 to the rotation axial center 11, the fluid in the mixing tank 400 is free from entering the conveying flow channel 100. When the sample and the diluent are evenly mixed in the mixing tank 400, the rotation frequency (rotational speed) is reduced or stopped, and the fluid in the mixing tank 400 fills the fourth micro flow channel 500 under the capillary force of the fourth micro flow channel 500. Then, the microfluidic substrate 10 is rotated again, and the fluid in the mixing tank 400 enters the conveying flow channel 100 through the fourth micro flow channel 500.

For example, the volume of the mixing tank 400 is greater than the sum of the volumes of the conveying flow channel 100 and the first fluid tank 210. Thus, in the process that the fluid enters the conveying flow channel 100 from the mixing tank 400, it can be ensured that there is a height difference between the fluid in the mixing tank 400 and the fluid in the conveying flow channel 100, making the fluid fill the conveying flow channel 100 and all the first fluid tanks 210.

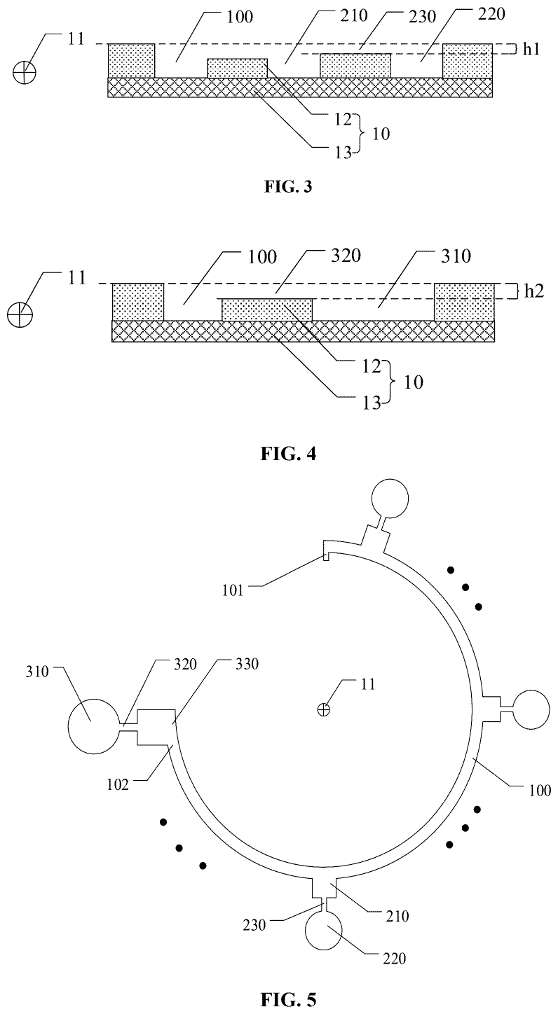

In some embodiments of the present disclosure, please referring to FIG. 3 and FIG. 4 again, the microfluidic substrate 10 may include a flow channel layer 12 and a base 13. The flow channel structure is formed in the flow channel layer 12. The base 13 is located at the other side, away from one side provided with the first fluid tank 210, the first micro flow channel 230, the second micro flow channel 320, the second fluid tank 220 and the waste liquid tank 310, of the flow channel layer 12. The base 13 is attached to the flow channel layer 12. In some embodiments of the present disclosure, the base and the flow channel layer may be integrally formed.

For example, in some embodiments of the present disclosure, the depth of a communicating between the conveying flow channel 100 and the first fluid tank 210 may be less than that of the conveying flow channel 100 and the first fluid tank 210 as shown in FIG. 3. Otherwise, the depth of the communicating part between the conveying flow channel 100 and the first fluid tank 210 may be set to equal to that of the conveying flow channel 100 and the first fluid tank 210, thus facilitating the fluid in the conveying flow channel 100 to enter the first fluid tank 210 under the action of centrifugal force.

It needs to be noted that in an embodiment of the present disclosure, the microfluidic substrate may also include structures such as a sample tank, a sample metering tank, a sample overflow tank, a diluent tank, a diluent metering tank, a diluent overflow tank, etc., the details of these structures may refer to the relevant designs in the current microfluidic substrate or microfluidic chip, and thus will not be repeated here.

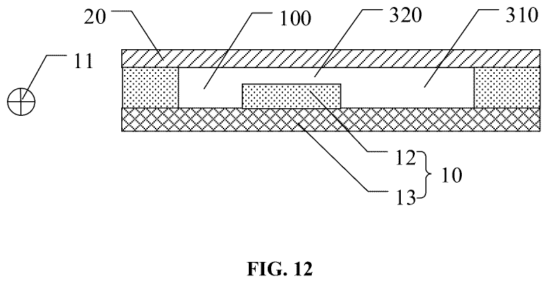

At least one embodiment of the present disclosure provides a microfluidic chip. As shown in FIG. 11 and FIG. 12, the microfluidic chip includes a cover plate 20 and the microfluidic substrate 10 in any of above embodiments. The cover plate 20 is aligned with and closed to the microfluidic chip substrate 10, and is located at one side provided with the first fluid tank 210, the first micro flow channel 230, the second micro flow channel 320, the second fluid tank 220 and the waste liquid tank 310, of the microfluidic substrate 10. The cover plate 20 and the microfluidic substrate 10 are bonded together in a watertight manner.

The above is only the preferred embodiment of this specification, and is not used to limit the present disclosure. Any modification, equivalent substitution etc. made within the spirit and principle of this specification should be included in the scope of protection of this specification.

1. A microfluidic substrate comprising a flow channel structure, wherein the flow channel structure comprises:
a conveying flow channel comprising an input end and an output end;
a plurality of detection assemblies arranged between the input end and the output end, wherein each detection assembly comprises a first fluid tank, a first micro flow channel and a second fluid tank, which are in communication with one another in turn; the first fluid tank communicates with the conveying flow channel, and a reagent is provided in at least one second fluid tank; and
a recovery assembly, comprising a waste liquid tank and a second micro flow channel, wherein the second micro flow channel is in communication with the waste liquid tank at one end, and is in communication with the output end of the conveying flow channel at another end; and
wherein a critical rotational speed of the first micro flow channel for blocking a fluid is set as a first rotational speed, and the second micro flow channel is configured to block the fluid at the first rotational speed.

2. The microfluidic substrate according to claim 1, wherein
the first micro flow channel is configured to have a first length and a first cross-sectional area, such that a fluid from the first fluid tank and a gas in the second fluid tank form a gas-liquid interface in the first micro flow channel at the first rotational speed; and
the second micro flow channel is configured to have a second length and a second cross-sectional area, such that a fluid from the conveying flow channel and a gas in the waste liquid tank form a gas-liquid interface in the second micro flow channel at the first rotational speed.

3. The microfluidic substrate according to claim 2, wherein
a critical rotational speed of the second micro flow channel for blocking the fluid is set as a second rotational speed, the microfluidic substrate has a rotation axial center, the detection assembly and the recovery assembly are located at one side, away from the rotation axial center, of the conveying flow channel, and the first fluid tank is configured to make the fluid in the conveying flow channel enter the first fluid tank at a third rotational speed;
the first rotational speed is greater than the third rotational speed, and the second rotational speed is not equal to the third rotational speed, or the first rotational speed is equal to the third rotational speed, and the second rotational speed is greater than or equal to the third rotational speed;
preferably, the recovery assembly further comprises a third fluid tank, the second micro flow channel communicates with the conveying flow channel through the third fluid tank, and the third fluid tank is configured to make the fluid in the conveying flow channel enter the third fluid tank at the third rotational speed.

4. The microfluidic substrate according to claim 3, wherein each of the first micro fluid channel and the second micro flow channel is a non-siphon flow channel; and
the first rotational speed is equal to the second rotational speed, where the first length is equal to the second length, and/or the first cross-sectional area is equal to the second cross-sectional area; or
the first rotational speed is less than the second rotational speed, where the first length is less than the second length, and/or the first cross-sectional area is greater than the second cross-sectional area.

5. The microfluidic substrate according to claim 3, wherein the first micro fluid channel is a non-siphon flow channel, the second micro flow channel is a siphon flow channel, and the second rotational speed is less than the third rotational speed; and
a distance from a part of the second micro flow channel to the rotation axial center is less than a distance from the output end to the rotation axial center.

6. The microfluidic substrate according to claim 1 4, wherein each detection assembly further comprises a buffer tank and a third micro flow channel;
the first fluid tank, the first micro flow channel, the buffer tank, the third micro flow channel and the second fluid tank are in communication in turn;
preferably, the third micro flow channel is configured to block the fluid at a fourth rotational speed, and the fourth rotational speed is greater than the first rotational speed; and
preferably, a sum of volumes of the second fluid tank and the buffer tank is not less than a volume of the first fluid tank.

7. The microfluidic substrate according to claim 1 4, wherein a shape of the conveying flow channel is a non-closed ring, and
the ring is a part of a circle, and a center of the circle where the ring is located is the rotation axial center;
the ring is a part of a non-circle, a distance from the input end to the rotation axial center is less than a distance from the output end to the rotation axial center, and a distance from the conveying flow channel to the rotation axial center increases gradually in a direction from the input end to the output end; or
the ring is a part of a non-circle, a distance from the input end to the rotation axial center is greater than a distance from the output end to the rotation axial center, and a distance from the conveying flow channel to the rotation axial center decreases gradually in a direction from the input end to the output end.

8. The microfluidic substrate according to claim 1 4, further comprising a mixing tank and a fourth micro flow channel, wherein the mixing tank communicates with the input end of the conveying flow channel through the fourth micro flow channel; and
a volume of the mixing tank is greater than or equal to a sum of volumes of the conveying flow channel and the first fluid tank.

9. The microfluidic substrate according to claim 1 4, comprising:
a flow channel layer, wherein the flow channel structure is formed in the flow channel layer;
a base, located at another side, away from one side provided with the first fluid tank, the first micro flow channel, the second micro flow channel, the second fluid tank and the waste liquid tank, of the flow channel layer; and
wherein the base is attached to the flow channel layer, or the base and the flow channel layer are integrally formed.

10. A microfluidic chip, comprising a cover plate and the microfluidic substrate according to claim 1, wherein the cover plate is aligned with and closed to the microfluidic chip, and is located at one side provided with a first fluid tank, a first micro flow channel, a second micro flow channel, a second fluid tank and a waste liquid tank, of the microfluidic substrate.

11. The microfluidic chip according to claim 10, wherein
the first micro flow channel is configured to have a first length and a first cross-sectional area, such that a fluid from the first fluid tank and a gas in the second fluid tank form a gas-liquid interface in the first micro flow channel at the first rotational speed; and
the second micro flow channel is configured to have a second length and a second cross-sectional area, such that a fluid from the conveying flow channel and a gas in the waste liquid tank form a gas-liquid interface in the second micro flow channel at the first rotational speed.

12. The microfluidic chip according to claim 11, wherein
a critical rotational speed of the second micro flow channel for blocking the fluid is set as a second rotational speed, the microfluidic substrate has a rotation axial center, the detection assembly and the recovery assembly are located at one side, away from the rotation axial center, of the conveying flow channel, and the first fluid tank is configured to make the fluid in the conveying flow channel enter the first fluid tank at a third rotational speed;
the first rotational speed is greater than the third rotational speed, and the second rotational speed is not equal to the third rotational speed, or the first rotational speed is equal to the third rotational speed, and the second rotational speed is greater than or equal to the third rotational speed;
preferably, the recovery assembly further comprises a third fluid tank, the second micro flow channel communicates with the conveying flow channel through the third fluid tank, and the third fluid tank is configured to make the fluid in the conveying flow channel enter the third fluid tank at the third rotational speed.

13. The microfluidic chip according to claim 12, wherein each of the first micro fluid channel and the second micro flow channel is a non-siphon flow channel; and
the first rotational speed is equal to the second rotational speed, where the first length is equal to the second length, and/or the first cross-sectional area is equal to the second cross-sectional area; or
the first rotational speed is less than the second rotational speed, where the first length is less than the second length, and/or the first cross-sectional area is greater than the second cross-sectional area.

14. The microfluidic chip according to claim 12, wherein the first micro fluid channel is a non-siphon flow channel, the second micro flow channel is a siphon flow channel, and the second rotational speed is less than the third rotational speed; and
a distance from a part of the second micro flow channel to the rotation axial center is less than a distance from the output end to the rotation axial center.

15. The microfluidic chip according to claim 10, wherein each detection assembly further comprises a buffer tank and a third micro flow channel; the first fluid tank, the first micro flow channel, the buffer tank, the third micro flow channel and the second fluid tank are in communication in turn;
preferably, the third micro flow channel is configured to block the fluid at a fourth rotational speed, and the fourth rotational speed is greater than the first rotational speed; and
preferably, a sum of volumes of the second fluid tank and the buffer tank is not less than a volume of the first fluid tank.

16. The microfluidic chip according to claim 10, wherein a shape of the conveying flow channel is a non-closed ring, and
the ring is a part of a circle, and a center of the circle where the ring is located is the rotation axial center;
the ring is a part of a non-circle, a distance from the input end to the rotation axial center is less than a distance from the output end to the rotation axial center, and a distance from the conveying flow channel to the rotation axial center increases gradually in a direction from the input end to the output end; or
the ring is a part of a non-circle, a distance from the input end to the rotation axial center is greater than a distance from the output end to the rotation axial center, and a distance from the conveying flow channel to the rotation axial center decreases gradually in a direction from the input end to the output end.

17. The microfluidic chip according to claim 10, further comprising a mixing tank and a fourth micro flow channel, wherein the mixing tank communicates with the input end of the conveying flow channel through the fourth micro flow channel; and
a volume of the mixing tank is greater than or equal to a sum of volumes of the conveying flow channel and the first fluid tank.

18. The microfluidic chip according to claim 10, comprising:
a flow channel layer, wherein the flow channel structure is formed in the flow channel layer;
a base, located at another side, away from one side provided with the first fluid tank, the first micro flow channel, the second micro flow channel, the second fluid tank and the waste liquid tank, of the flow channel layer, and
wherein the base is attached to the flow channel layer, or the base and the flow channel layer are integrally formed.
